(19) United States
(12) Patent Application Publication
(10) Pub. No.: US 2005/0023784 A1
(43) Pub. Date: Feb. 3, 2005

(54) Racing sulky

(76) Inventors: Thomas Glen Harmer, Hinsdale, IL (US); Edward Joseph Giroux, Highland, MI (US)

Correspondence Address: BEEM PATENT LAW FIRM, 53 W. JACKSON BLVD., SUITE 1352, CHICAGO, IL, 60604-3787, US

(21) Appl. No.: 10/865,297

(22) Filed: Jun. 10, 2004

Related U.S. Application Data
(63) Continuation-in-part of application No. 10/633,262, filed on Jul. 31, 2003.

(51) Int. Cl. B62C 1/08

(52) U.S. Cl. 280/63

(57) ABSTRACT

A sulky to be drawn by a horse provides one or more features including an offset between the center line of the sulky wheels and the center line of the horse, cast connectors with pilots, and wheels aligned with the direction of travel, substantially planar wheel sides.

This application is a Continuation-In-Part of application Ser. No. 10/633,262, filed on Jul. 31, 2003.

### BACKGROUND OF THE INVENTION

1. Field of the Invention

The present invention is directed to a horse drawn sulky, particularly to a racing sulky drawn by a horse in a harness racing competition.

2. Description of the Related Art

Horse racing with sulkies has been known for several millennia. Until now, however, several problems have persistently retarded the speed and efficiency of the horse and sulky during a race.

Many sulkies have rails situated so that the center line between the rails is aligned with the center of the horse, but it is known that if the center line between the rails is offset toward the inside of the track, i.e., toward the left side of the sulky if the race is run counterclockwise or to the right if the race is run clockwise around a track, it moves the horse closer to the inside of the track so that the horse is permitted to run a shorter distance than with centered rails. International patent application WO 93/19969 discloses a sulky where the rails and the seat are shifted so that the center line of the rails and the seat are offset from the wheels. The “Time Machine” sulky, manufactured by Fab Weld, is believed to have included straight offset rails welded at right angles to the top of the arch. However, the geometry of the offset rails on the Time Machine sulky and those disclosed in WO 93/19969 tends to cause the pull on the sulky to be slightly uneven and also gives the sulky an unbalanced appearance.

Wheels of sulkies typically are mounted after a sulky is assembled, and in many cases the wheels are unaligned with respect to the longitudinal direction of travel, for example, the front of a wheel being closer to the center of the sulky than the back so that the wheel is angled inwardly, or vice versa, so that the wheel is angled outwardly, in either event creating a plowing effect that slows the horse. Many times this misalignment goes undetected and, even if detected, uncorrected.

Generally, sulkies are made from tubes that are connected together via butt-welding. Tubes can be difficult to weld together while maintaining alignment, making it even more difficult to properly align the wheels of the sulky. Also, the butt-welding of tubes is known to be insecure, sometimes resulting in breaking during use of the sulky.

The wheels of sulkies typically are wire-spoked. According to the United States Trotting Association Sulky Performance Standard, it is required to cover the spokes on both sides of the wheel to prevent the foot of the horse from stepping through the wheel. The wire-spokes of sulky wheels typically form a conical shape on each side of the wheel so that the wheel is wider at the axle than at the rims, such as in U.S. Pat. No. 5,857,686 and international patent application WO 93/19969. The wheel covers are also typically generally conical in shape to complement the wire spokes. However, conical wheel covers result in increased wind drag, slowing the horse during the race.

Additionally, traditional sulkies have generally straight rails that are rigidly connected to an arch of the sulky. The straight and rigid rails can make it more difficult for the horse because the sulky tends to slide sideways during a turn as the sulky tends to be forced into a position directly behind the horse, i.e., to be forced by the harness and rails to the outside as the horse turns.

Attempts have been made to alleviate the problem of the sulky sliding, including U.S. Pat. No. 6,247,711, which uses pivotable wheels, and U.S. Pat. Nos. 4,863,180 and 5,183,279 which disclose a complicated connection between the rails and the arch that allows for lateral movement of the rails about a pivot axis. However, the pivoting assembly between the rail and the arch requires a complicated assembly of parts to work together to accommodate the lateral movement of the rails. The aforementioned sulkies may not meet the current 2003 standards of the United States Trotting Association Sulky Performance Standard, which is incorporated by reference as if reproduced herein.

What is needed is a sulky that overcomes the problems associated with the prior art.

### BRIEF SUMMARY OF THE INVENTION

In one aspect of the invention, a sulky includes a pair of laterally spaced wheels mounted generally at opposite ends of an arch, there being a first longitudinal center line between the wheels, a pair of rails with a first rail having a portion proximate the arch that is angled toward the first center line so that a second longitudinal center line between the distal ends is offset from the first longitudinal center line. The offset distal end center line allows the horse to be close to the inside of the track, shortening the distance the horse has to run during the race.

In another aspect, a sulky includes a generally tubular arch having two ends, a seat mounted to the arch between the ends, a pair of strut assemblies depending downwardly from generally opposite ends of the arch, each strut assemblies for receiving a wheel, a pair of rails mounted to the arch, one rail being mounted on one side of the seat and the other rail being mounted on the other side of the seat, each of the rails extending generally in a longitudinal direction from the arch to a distal end, the distal ends being adapted for harnessing the horse between the rails, wherein the arch and the strut assemblies are positioned for substantially longitudinal alignment of the wheels prior to welding.

In another aspect, the sulky includes a tubular arch including cast portions having pilots, a pair of rails each having an end slidably engaging one of the pilots, and a pair of wheel assemblies each having a tubular strut having an upper end slidably engaging another of the pilots and a wheel mounted on its lower end. The slidable engagement between the cast pilots and the tubes properly orients and aligns the parts of the sulky so that the wheels are substantially longitudinally aligned to prevent plowing or dragging of the wheels and provides for stronger welds between the tubes and the pilots.

In yet another aspect, the sulky includes a tubular arch, a pair of cast hollow 4-way connectors having four pilots, one of the pilots of each 4-way connector slidably engaging and welded to a corresponding end of the arch, a pair of rails, and a pair of wheel assemblies; each of the rails including a cast hollow T-connector having three pilots, a rear tube with one end slidably engaging and welded to another of the 4-way connector pilots and another end slidably engaging and welded to one of the T-connector pilots, a front end having one end slidably engaging and welded to another of the T-connector pilots, and a harnessing shaft slidably engaging and welded to an opposite end of the front tube; and each of the wheel assemblies including a pair of axle-receiving castings each having a slot and two pilots, a pair of tubular struts each having one end slidably engaging and welded to one of the 4-way connector pilots and another end slidably engaging and welded to one of the axle-casting pilots, a wheel mounted on an axle, the axle being received by the slots, a cast hollow Y-connector having three pilots, a tubular arm having one end slidably engaging another of the T-connector pilots and one end slidably engaging one of the Y-connector pilots, a pair of tubular legs, each having one end slidably connected to another of the Y-connector pilots, and another end slidably connected to another of the axle-receiving casting pilots.

In still another aspect, the sulky includes a generally tubular arch having two ends, a seat mounted to the arch between the ends, a pair of strut assemblies depending downwardly from generally opposite ends of the arch, there being a wheel mounted to each strut assembly, a pair of rails mounted to the arch, one rail being mounted on one side of the seat and the other rail being mounted on the other side of the seat, each of the rails extending generally in a longitudinal direction from the arch to a distal end, the distal ends of the rails being adapted for harnessing the horse between the rails, a pair of supports, one support being connected to one of the rails at one end thereof and to one of the strut assemblies at the other end thereof and the other support being connected to the other rail at one end thereof and to the other strut assembly at the other end thereof, wherein the connection between each support and the corresponding rail is adjustable to allow for substantially longitudinal alignment of the wheels.

In another aspect, a sulky for being drawn by a horse is provided having a generally tubular arch having two ends, a pair of laterally spaced wheels mounted generally at opposite ends of the arch, a seat mounted to the arch between the ends and the wheels, a pair of rails mounted to the arch and extending forwardly, one of the rails being mounted to the arch on one side of the seat, and the other rail being mounted to the arch on the other side of the seat, each rail having a proximal portion mounted to the arch and a distal portion pivotally connected to the proximal portion so that the distal portion can pivot with respect to the proximal portion, each of the distal portions having a distal end adapted for harnessing the horse between the rails.

Also in accordance with the present invention, a wheel assembly is provided for a sulky to be drawn by a horse. The wheel assembly includes a wheel having two sides with substantially planar covers on opposite sides of the wheel and substantially covering the tubular spokes. In another aspect of the invention, a pair of the novel wheel assemblies is mounted to generally opposite ends of an arch of a sulky.

These and other features and advantages are evident from the following description of the present invention, with reference to the accompanying drawings.

### BRIEF DESCRIPTION OF THE SEVERAL VIEWS OF THE DRAWINGS

FIG. 1 is a perspective view of a sulky of the present invention.

FIG. 2 is an elevation view of the sulky of FIG. 1.

FIG. 3 is a plan view of the sulky of FIG. 1.

FIG. 4 is an elevation view of a connection between a support and a rail of the sulky of FIG. 1 in a first position.

FIG. 5 is an elevation view of the connection between the support and the rail of the sulky of FIG. 1 in a second position.

FIG. 6 is an elevation view of a hinge along the rail of the sulky of FIG. 1.

FIG. 7 is a perspective view of the hinge along the rail of the sulky of FIG. 1.

FIG. 8 is a partial sectional view of a wheel and substantially planar wheel cover of the sulky of FIG. 1.

FIG. 9 is a close-up section view of the substantially planar wheel cover mounted to the wheel.

FIG. 10 is a cross-sectional view of an alternative embodiment of a connection between the support and the rail in a first position.

FIG. 11 is a cross-sectional view of the alternative embodiment of the connection between the support and the rail in a second position.

FIG. 12 is an elevation view of an alternative embodiment of a hinge along the rail of the sulky of FIG. 1.

FIG. 13 is a perspective view of an alternative embodiment of the sulky of the present invention.

FIG. 14 is an elevation view of the sulky of FIG. 13.

FIG. 15 is a plan view of the sulky of FIG. 13.

FIG. 16 is an end view of the sulky of FIG. 13.

FIG. 17 is an exploded elevation view of the sulky of FIG. 13.

FIG. 18 is an exploded plan view of the sulky of FIG. 13.

FIG. 19 is an exploded isometric view of a connector of the sulky of FIG. 13.

FIG. 20 is an exploded isometric view of an alternative connector.

FIG. 21 is an isometric view of a mud fender before being mounted to a sulky according to FIG. 13.

FIG. 22 is an isometric view of the mud fender mounted to the sulky of FIG. 13.

### DETAILED DESCRIPTION OF THE INVENTION

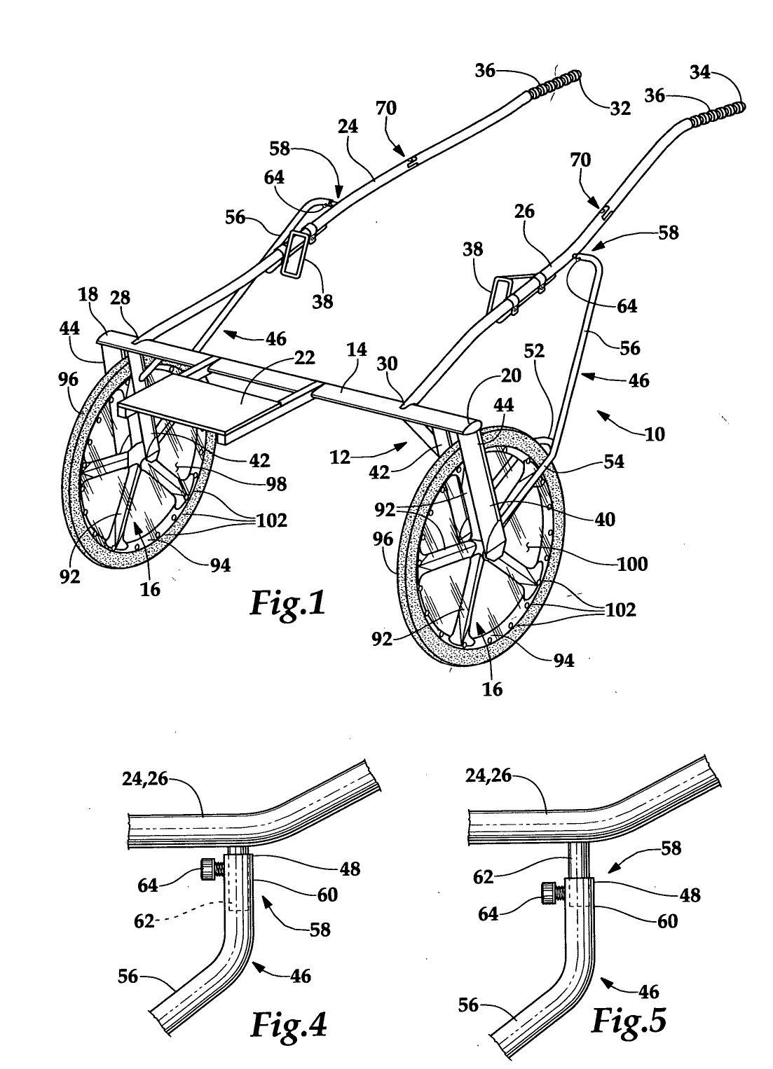

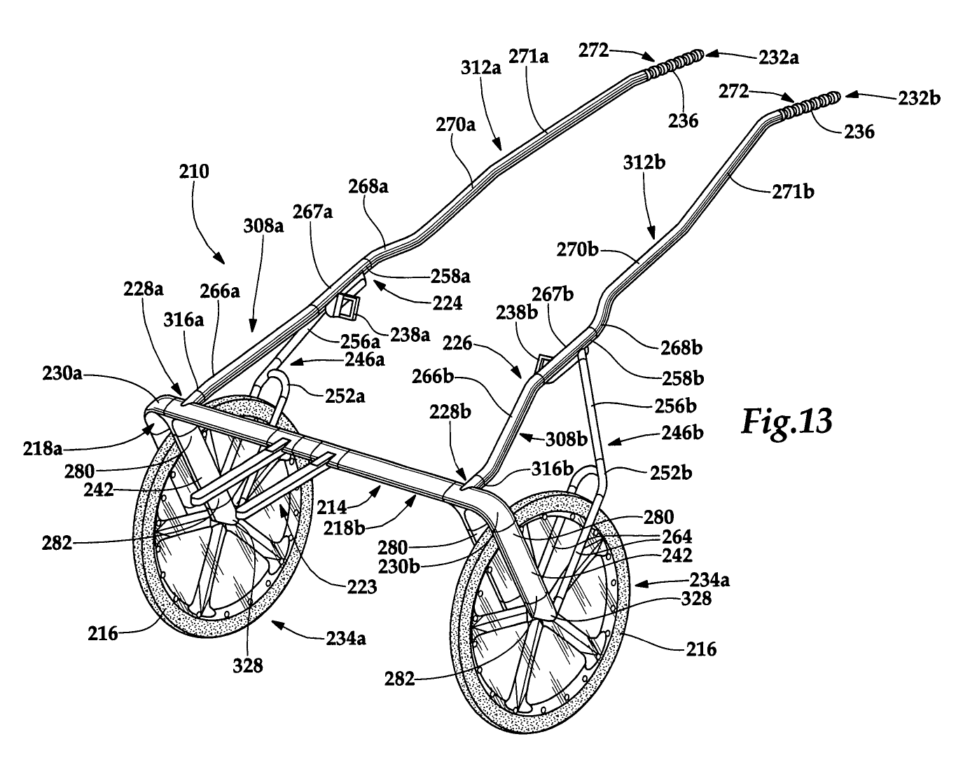

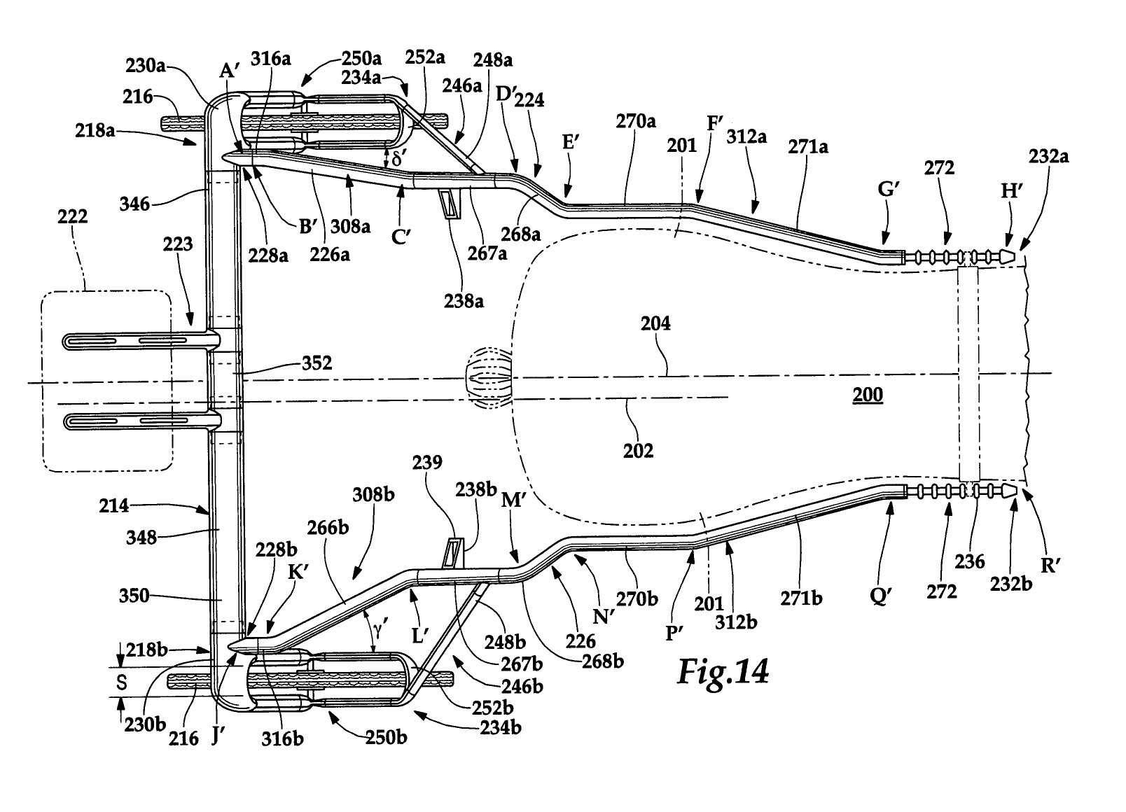

Referring to FIGS. 1 and 13, a horse drawn sulky 10, 210 is shown. Sulky 10, 210 of the present invention includes several features that reduce drag and other resistances and that improve the efficiency of the horse during a harness racing competition. Sulky 10, 210 is designed with advantages particularly helpful in a racing sulky. Removing resistances, such as wind drag, to decrease the amount of work the horse needs to exert is important during a race. Also, it is important to provide for the efficient transfer of energy between the horse and the sulky in the racing direction. Sulky 210 includes cast portions having pilots, which slidably engage tubes, providing for better alignment and a stronger connection between the parts of sulky 210.

First, one embodiment of a sulky 10, shown in FIGS. 1-12, will be described, followed by a discussion of a second embodiment sulky 210, shown in FIGS. 13-22.

1.0 Offset Sulky

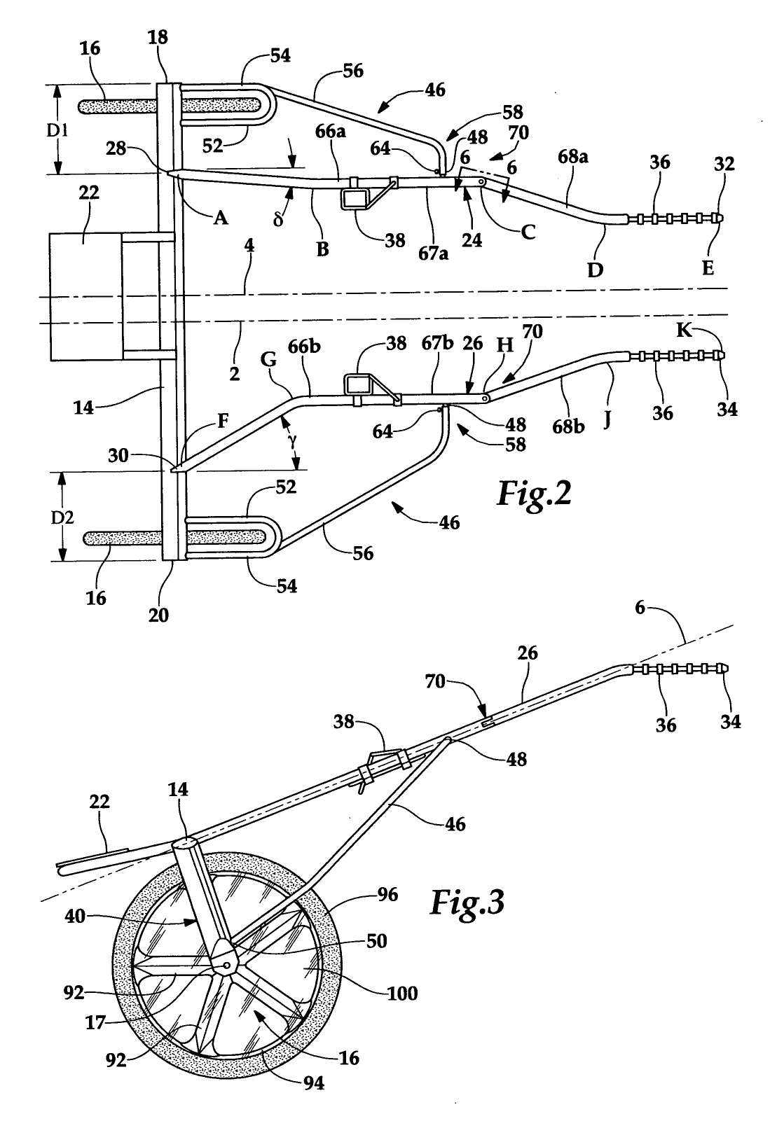

FIGS. 1 and 2 show a sulky 10 having a frame 12 with a generally tubular arch 14 with a pair of laterally spaced wheels 16 mounted generally at opposite ends 18, 20 of arch 14, with a center line 2 between wheels 16. A seat 22 is mounted on arch 14 between ends 18 and 20 for supporting a driver. In one embodiment, seat 22 is cantilevered to arch 14. In a preferred embodiment, shown best in FIGS. 1 and 3, arch 14 is streamlined to have an aerodynamic shape to reduce air resistance drag on sulky 10.

Sulky 10 also includes a pair of rails 24, 26 having proximal ends 28, 30 mounted to arch 14 and extending forwardly generally in the longitudinal direction of center line 2 to distal ends 32, 34. One of the rails is mounted on one side of seat 22 and the other rail is mounted on the other side of seat 22. For example, proximal end 28 of rail 24 is mounted on the left side of seat 22 and proximal end 30 of rail 26 is mounted on the right side of seat 22. Preferably, rails 24, 26 extend generally in a common rail plane 6, best seen in FIG. 3. Distal ends 32, 34 are adapted for harnessing to a horse between rails 24, 26. Distal ends 32, 34 can be harnessed to the horse by several conventional means, such as by bullets 36 shown in FIG. 2. There should be enough bullets 36 to allow for adjustable harnessing of the horse. In a preferred embodiment, there are more than three bullets, preferably six (as shown in FIG. 2) or seven bullets 36. A stirrup 38 is connected to each rail 24, 26 between proximal end 28, 30 and distal end 32, 34. In a preferred embodiment, stirrups 38 can be adjusted along generally parallel portions 67a, 67b of rails 24, 26 to accommodate drivers of different heights.

In one embodiment, best seen in FIGS. 1 and 8, each wheel 16 is mounted proximate an end 18, 20 of arch 14 by a strut assembly 40. Each strut assembly 40 includes an inner strut 42 and an outer strut 44, wherein the wheel 16 is mounted on an axle 17 extending between inner strut 42 and outer strut 44 so that wheel 16 is mounted between inner strut 42 and outer strut 44. Axle 17 can be mounted to strut assembly 40 by a conventional nut, or by a quick-release skewers mechanism. Preferably, inner strut 42 and outer strut 44 are streamlined, as shown best in FIG. 1, to reduce drag on sulky 10.

Turning to FIGS. 1, 2 and 3, sulky 10 can also include a pair of supports 46, each being mounted to a corresponding rail 24, 26 at a first end 48 and a corresponding strut assembly 40 at a second end 50. In one embodiment, supports 46 are fork assemblies having a main portion 56 mounted to rail 24, 26 that splits into an inner leg 52 and an outer leg 54 near wheels 16, wherein inner leg 52 connects to inner strut and outer leg 54 connects to outer strut 44.

1.1 Offset Rails

Turning to FIG. 2, sulky 10 of the present invention can also include a novel configuration of rails 24, 26 so that a center line 4 between distal ends 32, 34 of rails 24, 26 are offset from the center line 2 between wheels 16. Preferably rail center line 4 is offset toward the inside of the track from wheel center line 2, i.e., toward the left side, as shown in FIG. 2, if the race is run in a counterclockwise direction or toward the right side if the race is run in a clockwise direction. Offset rails 24, 26 allow the horse to be positioned closer to the inside of the track during a race, which lessens the actual distance the horse has to run.

Continuing with FIG. 2, inside rail 24 includes point A at proximal end 28, bend B in the racing direction from point A, point C in the racing direction from bend B, bend D in the racing direction from point C, and point E at distal end 32. Outside rail 26 includes point F at proximal end 30, bend G in the racing direction from point F, point H in the racing direction from bend G, bend J in the racing direction from point H, and point K at distal end 34.

Portion AB of inside rail 24 proximate arch 14 is angled toward center line 2 at an angle δ as portion AB extends from arch 14 toward distal end 28. Portion FG of outside rail 26 proximate arch 14 is angled toward center line 2 at an angle γ as portion FG extends from arch 14 toward distal end 30. Angle γ is larger than angle δ of portion AB of inside rail 24, so that center line 4 between distal ends 32, 34 is offset from center line 2 between wheels 16.

In one embodiment, angle γ of portion FG is between 15° and 45°, preferably between 20° and 35°, still more preferably about 30°, while angle δ of portion AB is between 0° and about 20°, preferably between about 3° and about 10°, still more preferably about 5°. The distance D1 between inside end 18 of arch 14 and proximal end 28 of inside rail 24 is preferably substantially equal to the distance D2 between outside end 20 and proximal end 30 of outside rail 26 so that the pull experienced by arch 14 by rails 24, 26 is generally equal and balanced. Also, the substantially equal distances D1, D2 between proximal ends 28, 30 and arch ends 18, 20 give sulky 10 an even and balanced appearance.

Preferably portion BC of inside rail 24 is substantially parallel to portion GH of outside rail 26, and to center lines 2 and 4 so that when stirrups 38 are adjusted along rails 24, 26, the stirrups remain generally the same distance apart.

1.2 Aligned Wheels

Turning to FIGS. 2, 4 and 5, sulky 10 of the present invention provides aligned wheels 16 that are substantially longitudinally aligned with center line 2, which corresponds to the direction the horse is pulling sulky 10. Sulky 10 ensures wheels 16 are aligned by either providing for adjustment of the wheels or by welding strut assemblies 40 to arch 14 and rails 24, 26 to arch 14 in a jig to ensure that wheels 16 will be aligned.

The alignment of wheels 16 is determined mainly by the orientation of strut assemblies 40 and rails 24, 26 in relation to arch 14. If strut assemblies 40 or rails 24, 26 are not oriented properly with arch 14, it is difficult to make wheels 16 aligned. Much of the alignment of strut assemblies 40 occurs during the manufacture of a sulky, however, sulky 10 advantageously provides for adjustments of wheels 16 after sulky 10 has been assembled.

Sulky 10 may include a tubular arch 14 having two ends 18, 20, a seat 22 mounted to arch 14 between ends 18, 20, a pair of strut assemblies 40 depending downwardly from generally opposite ends 18, 20 of arch 14, there being a wheel 16 mounted to each strut assembly 40, a pair of rails 24, 26 mounted to arch 14, one rail 24 being mounted on one side of seat 22 and the other rail 26 being mounted on the other side of seat 22, each rail 24, 26 extending generally in a longitudinal direction from arch 14 to a distal end 32, 34, a pair of supports 46, one support being connected to one rail 24 at one end thereof and to one of the strut assemblies 40 at the other end thereof, and the other support 46 being mounted to the other rail 26 at one end thereof and to the other strut assembly 40 at the other end thereof.

Sulky 10 includes an adjustable connection 58 between support 46 and rail 24, 26 at first end 48 to allow for alignment of wheels 16 in the longitudinal direction of center line 2. In one embodiment, shown in FIGS. 4 and 5, adjustable connection 58 includes a sleeve 60 at first end 48 of support 46 and an arm 62 connected to rail 24, 26. Both arm 62 and sleeve 60 are generally tubular wherein arm 62 has an outer diameter that is slightly smaller than the inside diameter of sleeve 60 so that sleeve 60 can slide along arm 62 to change the length of adjustable connection 58. Adjustable connection 58 also includes a locking means, such as a set screw 64 or other fastener, to lock sleeve 60 in place relative to arm 62. When set screw 64 is in a tightened mode, sleeve 60 is fixed so that it cannot move relative to arm 62, and when set screw is in an untightened mode, sleeve 60 is free to slide along arm 62.

As shown in FIGS. 1-3, supports 46 are connected to strut assemblies 40 at second ends 50. As sleeve 60 at first end 48 slides along arm 62, it moves support 46 inwardly toward center line 2, or outwardly away from center line 2. Because of the connection between support 46 and strut assembly 40, as the support moves inwardly or outwardly, strut assembly 40 is directed either toward center line 2 or away from it. For example, if it is determined that the right wheel 16 is misaligned so that the front of the wheel is pointing inwardly, set screw 64 can be loosened and sleeve 60 can be slid outwardly along arm 62. As sleeve 60 slides outwardly, support 46 also moves outwardly, causing strut assembly 40 to be directed slightly in a clockwise direction as you are looking down on sulky 10. Sleeve 60 slides outwardly until right wheel 16 is aligned properly, and set screw 64 is retightened to lock sleeve 60 with respect to arm 62.

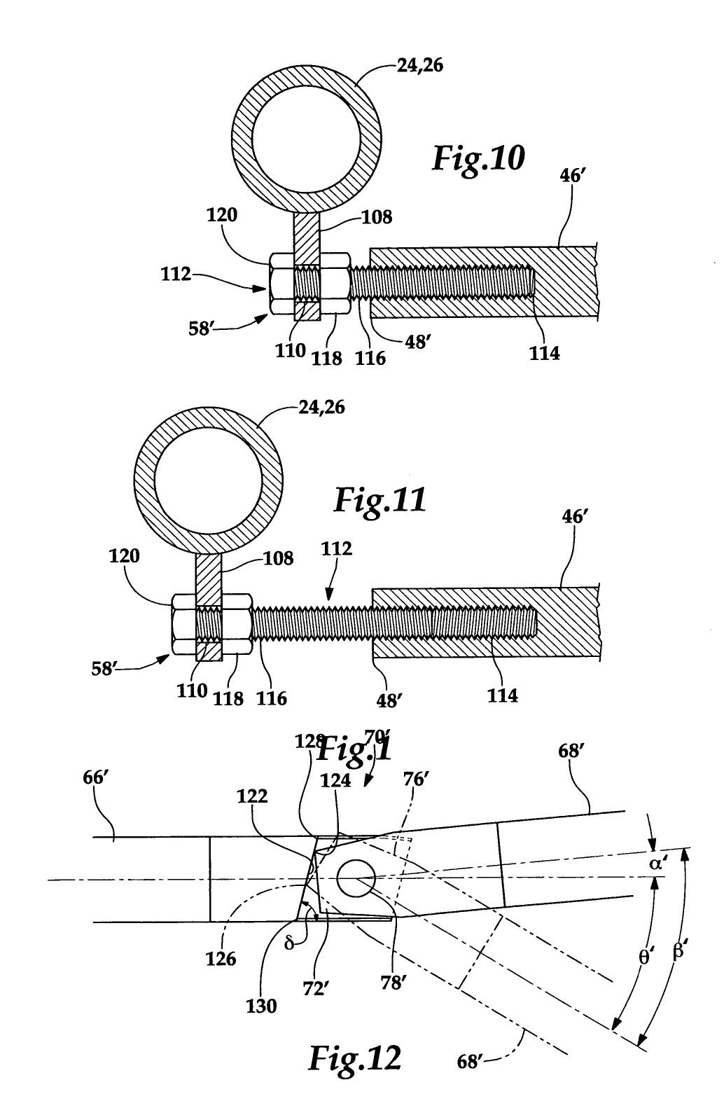

Turning to FIGS. 10 and 11, an alternative embodiment of adjustable connection 58′ is shown. Adjustable connection 58′ includes a flange 108 extending from rail 24, 26, wherein flange 108 has a bore 110 through which an adjustable fastener, such as a bolt 112, can be extended. Supports 46′ include a threaded hole 114 for receiving the threaded shank 116 of bolt 112. Support 46′ can be adjusted inwardly or outwardly, i.e. right to left in FIGS. 10 and 11, by rotating bolt 112. Hole 114 can receive a significant portion of bolt shank 116, as shown in FIG. 10, so that first end 48′ of support 46′ is relatively close to rail 24, 26, which aligns the front of wheel 16 inwardly. Bolt 112 can be rotated, i.e., manually or with a rotary driving tool such as a wrench, so that the threads of shank 116 engage with the threads of hole 114, forcing first end 48′ of support 46′ away from rail 24, 26, as shown in FIG. 11, thereby aligning the front of wheel 16 outwardly. A nut 118 can also be engaged with shank 116 to clamp flange 108 between the head 120 of bolt 112 and nut 118 in order to keep bolt 112 fixed relative to flange 108.

In another embodiment of the invention, sulky 10 is manufactured to ensure that strut assemblies 40 and wheels 16 are properly aligned with arch 14, rails 24, 26 and center line 2. To ensure that wheels 16 are aligned, strut assemblies 40 and arch 14 are placed in a jig (not shown), and strut assemblies 40 and arch 14 are positioned with the jig to ensure that strut assemblies are oriented so they are substantially normal to arch 14 prior to attaching strut assemblies 40 and arch 14 together, such as by welding or other attaching means. The jig positions arch 14 and strut assemblies 40 to ensure substantially longitudinal alignment of wheels 16 with rails 24, 26 and center line 2 before welding sulky 10 together. After alignment is confirmed, the pieces are attached, such as by welding, so that the strut assemblies and the arch 14 are aligned properly.

A similar method can be applied to ensure that the rails 24, 26 are oriented properly with respect to arch 14. Arch 14 and each rail 24, 26 are placed in a jig (not shown), and rails 24, 26 and arch 14 are aligned by the jig to ensure that arch 14 and rails 24, 26 are oriented properly, before rails 24, 26 are welded to arch 14.

Each alignment and welding step, i.e., between strut assemblies 40 and arch 14, and between arch 14 and rails 24, 26 can be performed separately, with a separate jig for each alignment and welding step, or a combined jig can be used to align all the pieces together at essentially the same time.

1.3 Flat Wheel Covers

Turning to FIGS. 1, 8, and 9, in another aspect of sulky 10 of the present invention, sulky 10 includes generally tubular arch 14 having two ends 18, 20, seat 22 mounted to arch 14 between ends 18, 20, a pair of rails, an inside rail 24 being mounted to arch 14 on the left side of seat 22, as shown in FIG. 2, the other outside rail 26 mounted to arch 14 on the right side of seat 22, wherein rails 24, 26 extend in a generally longitudinal direction from arch 14 to distal ends 32, 34 adapted for harnessing the horse between rails 24 and 26, a pair of laterally spaced wheel assemblies 87 mounted generally at opposite ends of arch 14, the wheel assemblies being designed to minimize drag due to air resistance. Each wheel assembly 87 includes a wheel 16 having an inside side 88, an outside side 90, a set of tubular spokes 92, a rim 94, a pair of substantially planar covers 98, 100 with an inside cover 98 being mounted on inside side 88 of wheel 16 and an outside cover 100 being mounted on opposite side 90 of wheel 16 for substantially covering spokes 92.

Tubular spokes 92 are larger than wire spokes so that each spoke 92 is stronger and can support more weight than a wire spoke. Also each spoke 92 is only wide enough between sides 88 and 90 to support the desired weight, but is not so wide that spokes 92 protrude past rim 94, so that no part of wheel 16 is wider than rim 94 and tire 96. Preferably, spokes 92 are flattened somewhat, having a generally oval or elliptically shaped cross section, as is best seen in FIG. 1, to ensure that spokes 92 are narrower than rim 94. Spokes 92 allow covers 98, 100 to be substantially planar, as shown in FIGS. 8 and 9, so that wheels 16 have a generally flat or substantially vertical planar profile, greatly reducing the drag on wheels 16, and hence on sulky 10. It has been found that wheels 16 with substantially planar covers 98, 100 allows for a decrease in drag of as much as four pounds or more at 30 miles per hour, allowing a horse to run about three or more lengths faster, per mile, than with conventional wheels.

Preferably there are five tubular spokes 92, as is shown in FIG. 1, evenly spaced around wheel 16 so that rim 94 and tire 96 are evenly supported. An example of a suitable wheel that can be used with sulky 10 is the Select K wheel manufactured by Bontrager Wheelworks and Components.

Covers 98, 100 are mounted to wheel 16, such as by a plurality of fasteners 102, such as Allen headed screws, shown in FIG. 1. Enough fasteners 102 should be used to ensure that covers 98, 100 are securely connected to wheels 16. In one embodiment, between 5 and 30, preferably between 10 and 20, still more preferably 15 fasteners, per cover, are used to mount covers 98, 100 to wheels. Preferably, fasteners 102 are mounted evenly and equidistantly around wheels 16 so that no portion of a cover 98, 100 protrudes out from rim 94, creating an uneven drag on wheel 16. In one embodiment, covers 98, 100 are mounted to rims 94 of wheels 16.

It is preferred that covers be removable so that they can be interchanged onto one or more wheels, and to allow for maintenance, such as refilling tires 96, or replacement of a wheel 16 or cover 98, 100. In one embodiment, covers 98, 100 are mounted to wheels 16 using Velcro 104 on covers 98, 100 and complementary Velcro 106 on wheel 16, best seen in FIG. 9, or other mounting means. In one embodiment, Velcro 106 is mounted on rim 94. Preferably Velcro 104 and 106 have a width that substantially covers the thickness of rim 94. Velcro 104, 106 should be mounted around enough of the circumference of rim 94 to ensure that covers 98, 100 remain mounted to wheel 16 during a race. In one embodiment, rim 94 has a thickness of between about 3/8 inch and about 1/2 inch, and Velcro 104, 106 has a width of between about 1/4 inch and about 3/8 inch, preferably about 3/8 inch to cover a significant portion of rim 94. Also, preferably Velcro 106 covers substantially the entire circumference of rim 94.

In a preferred embodiment, covers 98, 100 are mounted to wheel 16 so that covers 98, 100 are substantially recessed beneath the edge of tire 96, preferably so covers 98, 100 are flush or below the edge of tire 96, as is shown in FIG. 9. Recessed covers 98, 100 are preferred so that covers 98, 100 do not protrude past tires 96, reducing the likelihood that covers 98, 100 will interfere or strike an obstruction, such as another sulky's wheel or debris or some other obstruction on the racetrack, and to minimize the drag created by covers 98, 100.

Covers 98, 100 are preferably made out of plastic or other resilient materials. Covers 98, 100 can be solid, opaque, colors, or they can be transparent. Covers 98, 100 should be durable enough to withstand bumping by other sulkies, or kicking by a horse. Also, the material of covers 98, 100 should be chosen to minimize the noise transmitted between covers 98, 100 and wheels 16, as a horse racing track can be very bumpy and full of divots due to the hooves of several horses running on a dirt race track.

1.4 Hinged Rails

Continuing with FIG. 2, in another embodiment sulky 10 includes rails 24, 26 that are hinged to allow generally independent tracking of the horse and sulky 10, so that the sulky will not tend to slide sideways in a turn.

Hinged inside rail 24 includes a proximal portion 66a between points A and C mounted to arch 14 on the inside, or left, of seat 22 and a distal portion 68a between points C and E pivotally connected to proximal portion 66a so that distal portion 68a can pivot in rail plane 6 with respect to proximal portion 66a. Similarly, hinged outside rail 26 includes a proximal portion 66b between points F and H mounted to arch 14 on the outside, or right, of seat 22 and a distal portion 68b between points H and K pivotally connected to proximal portion 66b so that distal portion 68b can pivot substantially in the rail plane 6 with respect to proximal portion 66b. Distal portions 68a, 68b preferably pivot through a generally lateral arc to permit lateral tracking of sulky 10 as the horse turns. Distal portions 68, 68b are adapted for harnessing the horse between rails 24, 26.

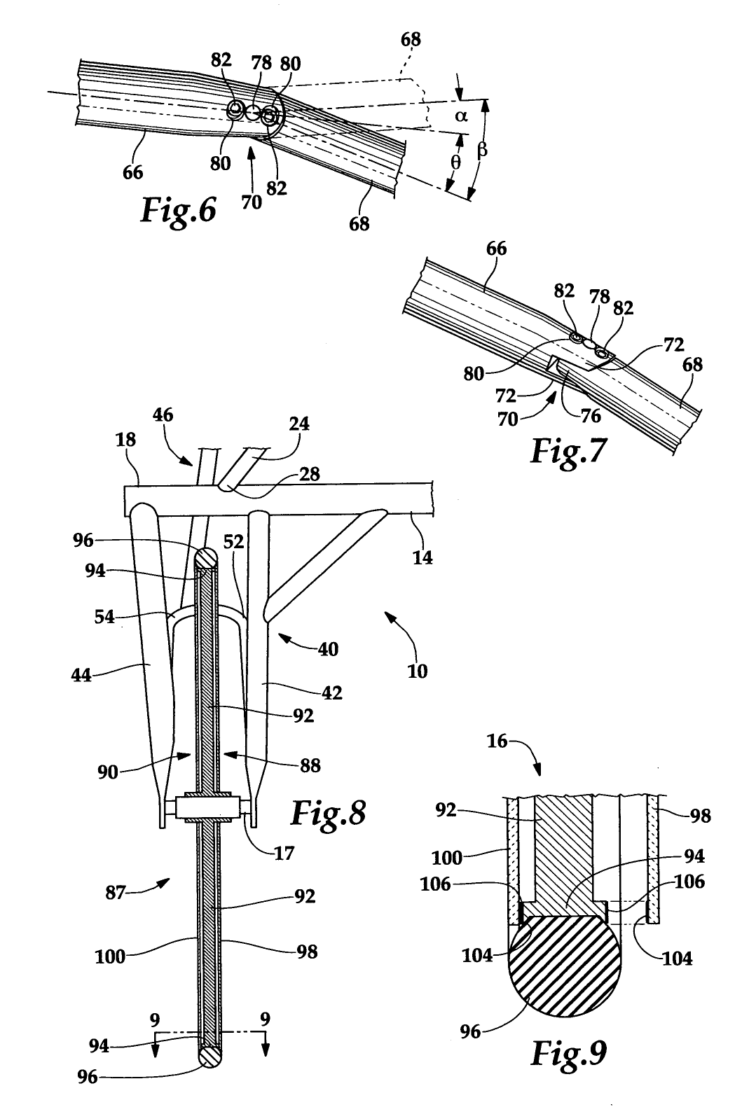

Turning to FIGS. 6, 7 and 12, in a preferred embodiment, distal portions 68, 68b are pivotally connected to proximate portions 66, 66′ by a hinge 70, 70′, wherein hinge 70, 70′ allows the pivotal motion of distal portion 68, 68′ generally within rail plane 6. Preferably, hinge 70, 70′ is adapted to only allow distal portion 68, 68′ to pivot over a limited range with respect to proximal portion 66, 66′ so that rails 24, 26 will not be difficult for the driver to control.

In one embodiment, shown in FIGS. 6 and 7, one of the portions 66, 68 (proximal portion 66 in FIG. 7) includes one or more wings 72 that frame a recess 74, while the other portion 66, 68 (distal portion 68 in FIG. 7) includes a complementary tongue 76 that abuts wings 72 and fits within recess 74, wherein wings 72 and tongue 76 are generally parallel to rail plane 6. A pivot pin 78 is inserted through wings 72 and tongue 76, wherein pivot pin 78 is generally normal to rail plane 6 so that distal portion 68 will pivot generally within rail plane 6. One of the wings 72 also includes a pair of oblong holes 80 longitudinally spaced slightly from pivot pin 78. A set screw 82 is mounted through each hole 80 onto tongue 76 so that the heads of set screws 82 are in holes 80. Holes 80 are oblong in a direction that allows the heads to slide along holes 80 as distal portion 68 pivots with respect to proximal portion 66. However, when each head reaches an end of a corresponding oblong hole 80, the distal portion 68 will not be able to continue pivoting in that direction with respect to proximal portion 66.

Turning to FIG. 6, in one embodiment, oblong holes 80 are cut into one of wings 72 in such a way to allow distal portion 68 to pivot inwardly toward the longitudinal direction of center line 2 (clockwise in FIG. 6) at an angle θ of between about 5° and about 45°, preferably between about 10° and about 30°, and still more preferably about 15° and holes 80 allow distal portion 68 to pivot outwardly from the longitudinal direction of center line 2 (counterclockwise in FIG. 6) at an angle α of between 0° and about 15°, preferably between about 2° and about 10°, still more preferably about 5°, so that the total range β in which distal portion 68 can pivot with respect to proximal portion 66 is a limited range of between about 5° and about 60°, preferably between about 10° and about 40°, and still more preferably about 20°.

In an alternative embodiment, shown in FIG. 12, wings 72′ have a generally angled off shape, as opposed to the rounded shaped of wings 72 shown in FIG. 6, and a wall 122 is included adjacent to tongue 46′. Angled wings 72′ include edges 124, 126 that come into contact with wall 122 so that distal portion 68′ will not be able to continuing pivoting with respect to proximal portion 66′. As shown in FIG. 12, wherein wings 72′ are on distal portion 68′ and wall 122 is on proximal portion 66′, distal portion 68′ can pivot from being angled outwardly at an angle α′ wherein outer edge 124 is in contact with wall 122 to being angled inwardly at an angle θ′ wherein inner edge 126 is in contact with wall 122. In a preferred embodiment, wall 122 is angled at an angle δ relative to the axis of proximal portion 66′ so that the outside end 128 of wall 122 is closer to distal portion 68′ than inside end 130 of wall 122, as shown in FIG. 12. An angled wall 122 is preferred so that inside angle θ is larger than outside angle α′, however, wall 122 could be angled in the opposite direction or wall 122 could be generally perpendicular to the axis of proximal portion 66′.

Preferably, hinges 70, 70′ allow distal portions 68, 68′ to pivot with respect to proximal portions 66, 66′ over enough of a lateral range to allow the horse pulling sulky 10 to have enough lateral freedom of movement around a turn. It has been found that a horse will use between about 1 inch and about 1½ inches of lateral movement relative to a sulky when negotiating a turn, therefore, it is preferred that hinges 70, 70′ of sulky 10 allow for at least this much lateral movement for the horse. However, too much lateral movement can allow the horse to turn too quickly and can make it difficult to control the sulky. In one embodiment, hinges 70, 70′ allow distal portions 68, 68′ to pivot so that distal ends 32, 34 laterally move over a predetermined total lateral range of between about 1 inch and about 1 foot, preferably between about 3 inches and about 6 inches, still more preferably between about 4 inches and about 4½ inches as distal portions 68, 68′ pivot with respect to proximal portions 66, 66′.

2.0 Sulky with Cast Connectors

Turning to FIGS. 13 and 14, sulky 210 is made from tubular parts, including a tubular arch 214, tubular rails 224, 226, and tubular struts 242. As described above, butt-welding tubular parts together while keeping the desired alignment can be difficult and butt-welding may not be strong enough to securely and optimally connect the tubes together for sustained use of the sulky. Therefore, in one embodiment, shown in FIGS. 13-16, cold-drawn or cold-rolled tubular parts of sulky 210 are joined by cast connectors having pilots which properly align the tubular parts with the cast parts and provide for welded connections that are substantially stronger than butt-welding.

2.1 Cast Connectors with Pilots

Continuing with FIGS. 13-16, sulky 210 comprises a tubular arch 214 including cast portions, such as the hollow, tubular connectors 230a, 230b having pilots 274a, 274b, 276a, 276b, 278a, 278b, 279a, 279b, a seat assembly 223 depending from arch 214, a pair of tubular rails 224, 226 each having a proximal end 228a, 228b slidably engaging one of the pilots 276a, 276b and a distal end 232a, 232b adapted for harnessing to horse 200, and a pair of wheel assemblies 234a, 234b, each depending from an opposite end 218a, 218b of arch 214, each wheel assembly 234a, 234b comprising a tubular strut 242 having an upper end 280 slidably engaging one of the pilots 278a, 278b, 279a, 279b and a wheel 216 mounted to lower end 280 of strut 242. Preferably, after slidably engaging tubes of arch 214, rails 224, 226, and struts 242, cast portions, i.e., cast connectors 230a, 230b, and the tubes are welded together at the pilots, providing a sturdy connection.

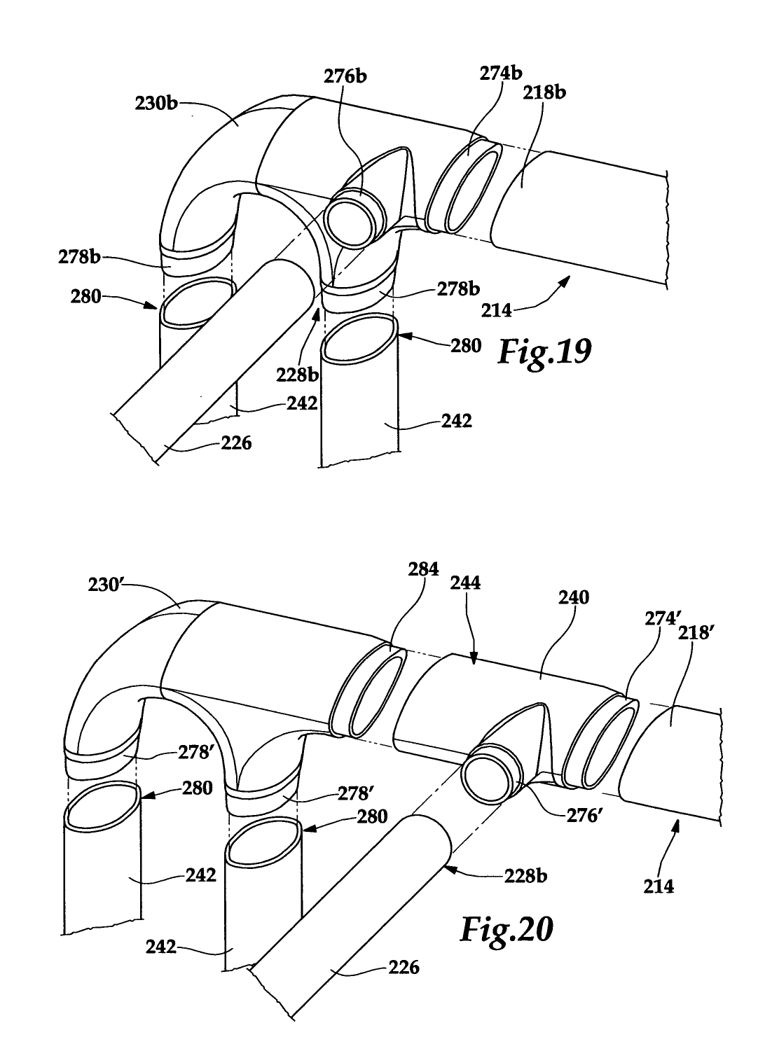

Arch 214 may be made from one or more tubes, which may include one or more cold-drawn or cold-rolled tubes, and includes two ends 218a, 218b and the cast portions may comprise a cast connector 230a toward the inside of the track, i.e. the left connector 230a (FIG. 14) in the U.S. or the right connector in Australia, and a cast connector 230b toward the outside of the track, i.e. the right connector 230b (FIG. 14), wherein each connector 230a, 230b has three pilots, and preferably four pilots, as shown in FIG. 19, wherein a laterally extending pilot 274a, 274b of each connector 230a, 230b slidably engages a corresponding end 218a, 218b, a forwardly extending pilot 276a, 276b of connector 230a, 230b slidably engages a proximal end 228a, 228b of a corresponding rail 224, 226, and a downwardly extending pilot 278a, 278b, 279a, 279b slidably engages upper end 280 of tubular strut 242.

Turning to FIG. 20, an alternative embodiment of the cast portions comprise cast connectors 240 each having at least two pilots 274′, 276, and second cast connectors 230′ each having at least one pilot 278′, 279′, wherein one of cast connector 240 and cast connector 230′ includes a laterally extending pilot 284 for slidably engaging the other of cast connector 240 and cast connector 230′. Tubular arch 241 includes two ends 218′, wherein each end 218′ is slidably engaged with one of the pilots 274′ of a corresponding connector 240, proximal end 228a, 228b is slidably engaged with a forwardly extending pilot 276′ of cast connector 240, and upper end 280 of tubular strut 242 is slidably engaged with the downwardly extending pilot 278′, 279′ of cast connector 230′. In one embodiment, shown in FIG. 20, cast connector 230′ includes laterally extending pilot 284 that is slidably engaged within an end 244 of cast connector 240. Preferably, arch 214 includes a pair of cast connectors 240, with one connector 240 connected to one end 218′ of arch 214 (as shown in FIG. 20) and another connector (not shown) which is a mirror image of connector 240 slidably engaging the other end of arch 214.

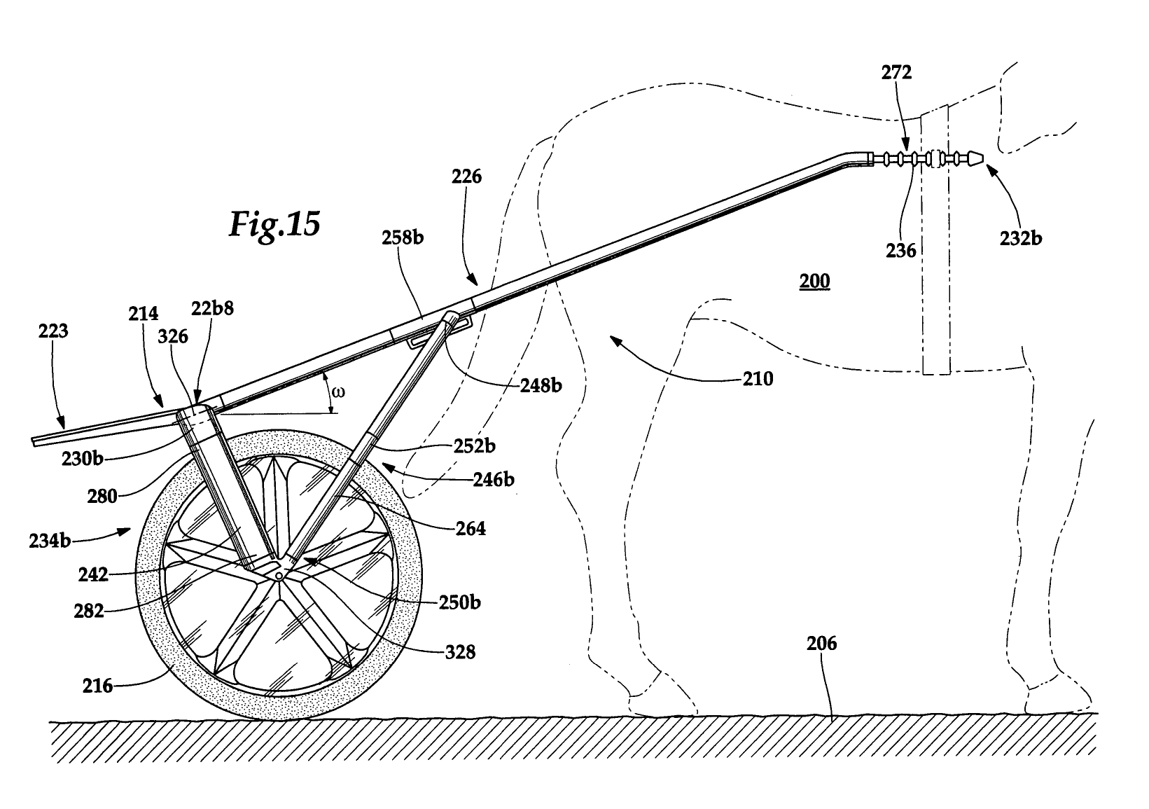

Preferably, arch 214, struts 242 and supports 246 include tubes with a streamlined, airfoil-type cross section having a major axis running generally in the longitudinal direction, and a minor axis extending vertically. In one embodiment, best seen in FIG. 15, the major axis 326 of arch 214 is angled slightly with respect to the ground 206 when rails 224, 226 are harnessed to horse 200 so that arch 214 is not substantially parallel to ground 206. In one embodiment, arch 214 is angled at an angle ω of between about 2° and about 10°, preferably about 5° with respect to ground 206. The slightly angled arch 214 is believed to provide some lift and that the angled arch 214 places seat assembly 223 in a more advantageous position for the driver during a race.

2.2 Wheel Assemblies

Turning to FIGS. 13, 16, and 19, preferably, each wheel assembly 234a, 234b includes a pair of tubular struts 242 each having an upper end 280 and a lower end 282, and each connector 230a, 230b is a 4-way connector having four pilots 274a, 274b, 276a, 276b, 278a, 278b, 279a, 279b. Upper end 280 of each strut 242 slidably engages a corresponding downwardly depending pilot 278a, 278b, 279a, 279b, and wheel 216 is mounted between lower ends 282 of the pair of struts 242.

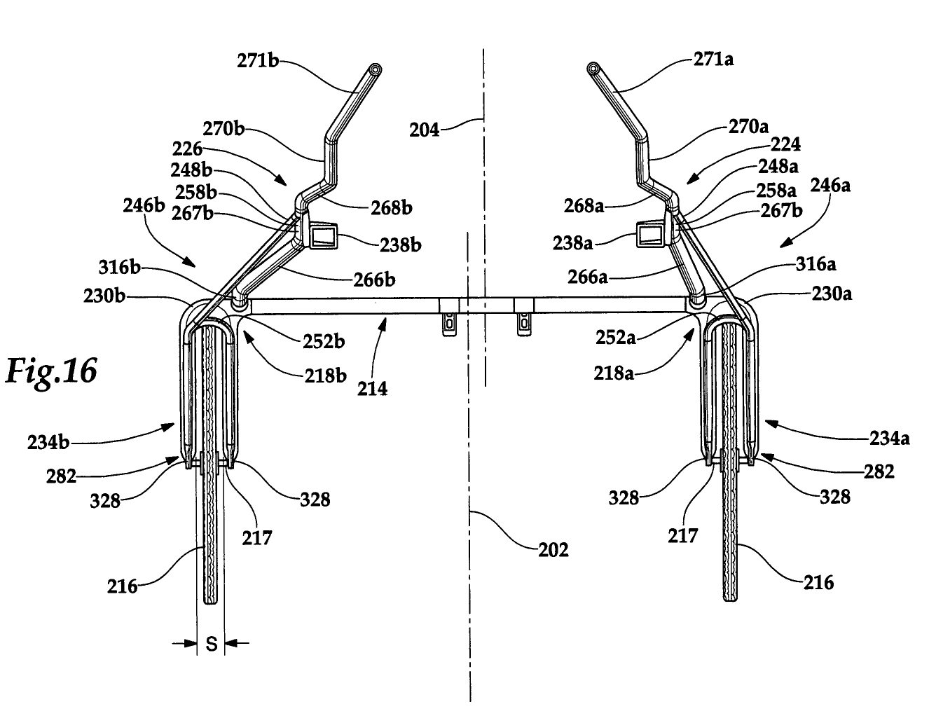

A space is created between the pair of struts 242 above wheel 216 of each wheel assembly 234. In prior sulkies, it was possible for a horse's hoof to fit in this space, and in some cases become caught. Sulky 210 provides a predetermined distance S between struts 242 (see FIG. 16) that is small enough to prevent a horse hoof from fitting between struts 242. In one embodiment, best seen in FIG. 16, the small distance S between struts 242 is accomplished by having struts 242 that are laterally wide enough to provide the space between struts having the predetermined distances S while also providing a strut center-to-center distance at lower end 282, i.e. at axle-castings 328, of about 4½ inches, as required by the United States Trotting Association Sulky Performance Standards. Preferably, the predetermined distance S is between about 2 inches and about 4 inches, preferably about 3 inches.

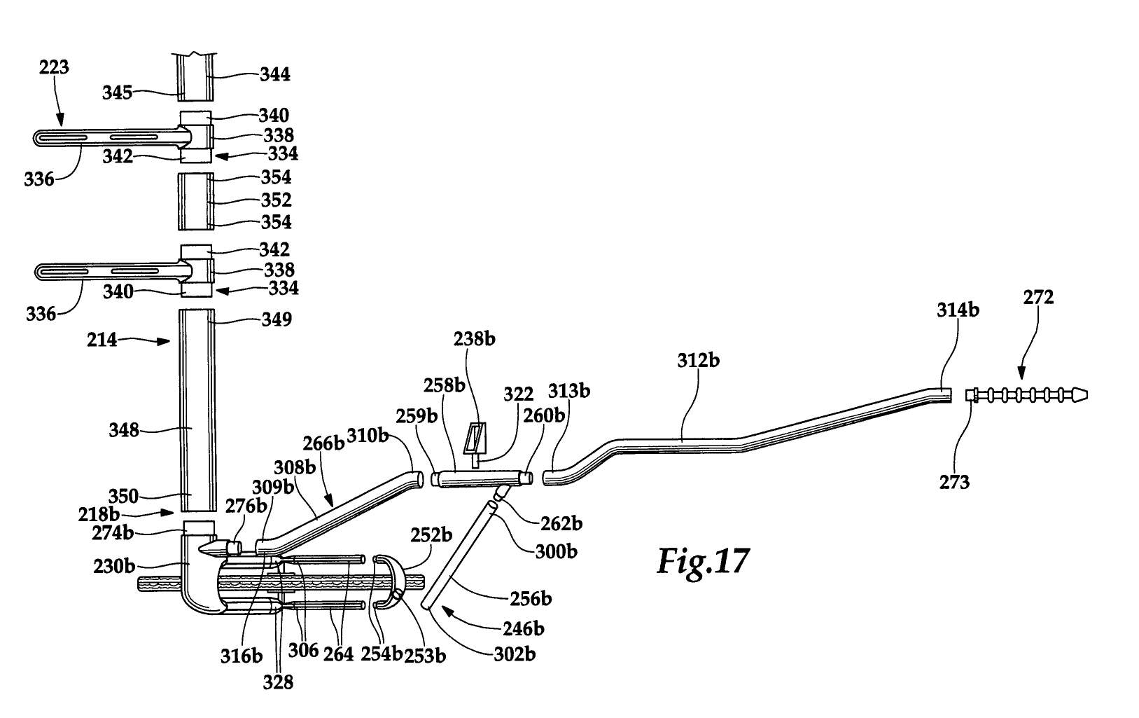

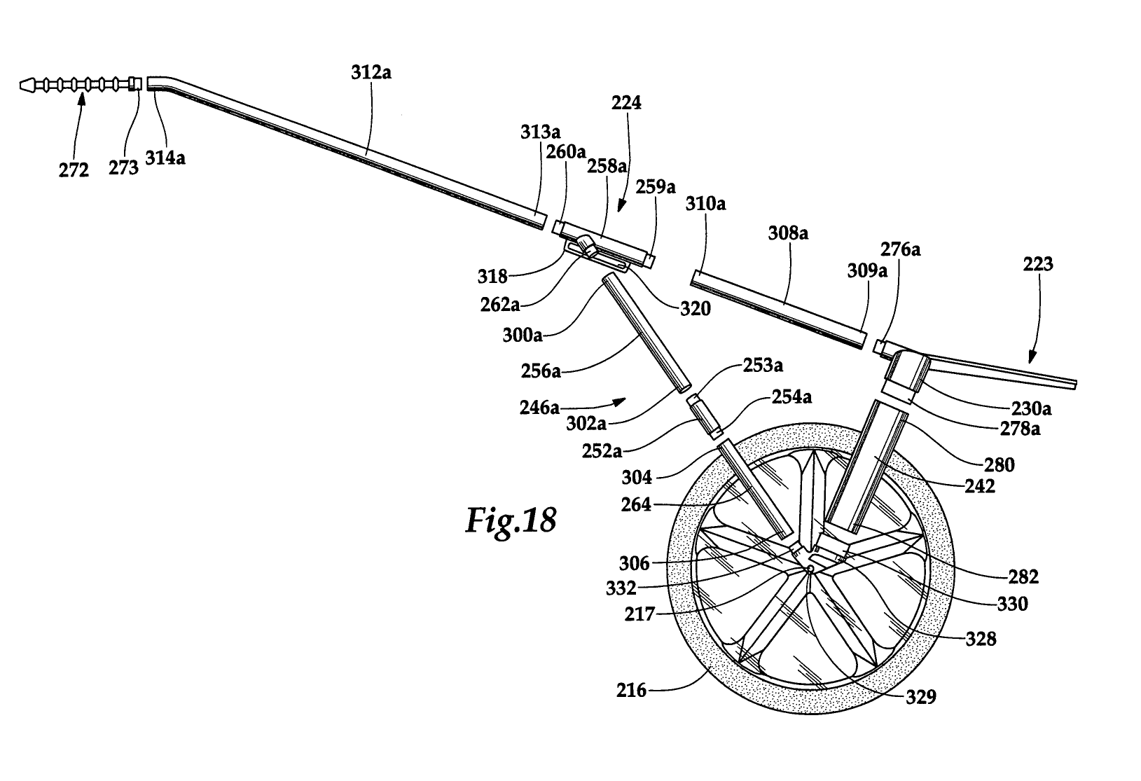

Turning to FIGS. 13-16, each wheel assembly 234a, 234b of sulky 210 may include a support 246a, 246b with a front end 248a, 248b connected to a corresponding rail 224, 226 and a rear end 250a, 250b connected to one of the struts 242. As shown in FIGS. 17 and 18, each support 246a, 246b may include a cast generally Y-shaped connector 252a, 252b having three pilots 253a, 253b, 254a, 254b, a tubular arm 256a, 256b having a front end 300a, 300b connected to the corresponding rail 224, 226 and a rear end 302a, 302b slidably engaged with a forwardly extending pilot 253a, 253b of Y-connector 252a, 252b, and a pair of tubular legs 264 each having a front end 304 slidably engaging one of the rearwardly extending Y-connector pilots 254a, 254b and a rear end 306 connected to one of the pair of struts 242. When sulky 210 has distal ends 232a, 232b that are offset from wheels 216, as described below, an outside arm 256b is longer than inside arm 256a, as shown in FIG. 14, so that wheels 216 are properly aligned.

2.3 Mud Fenders

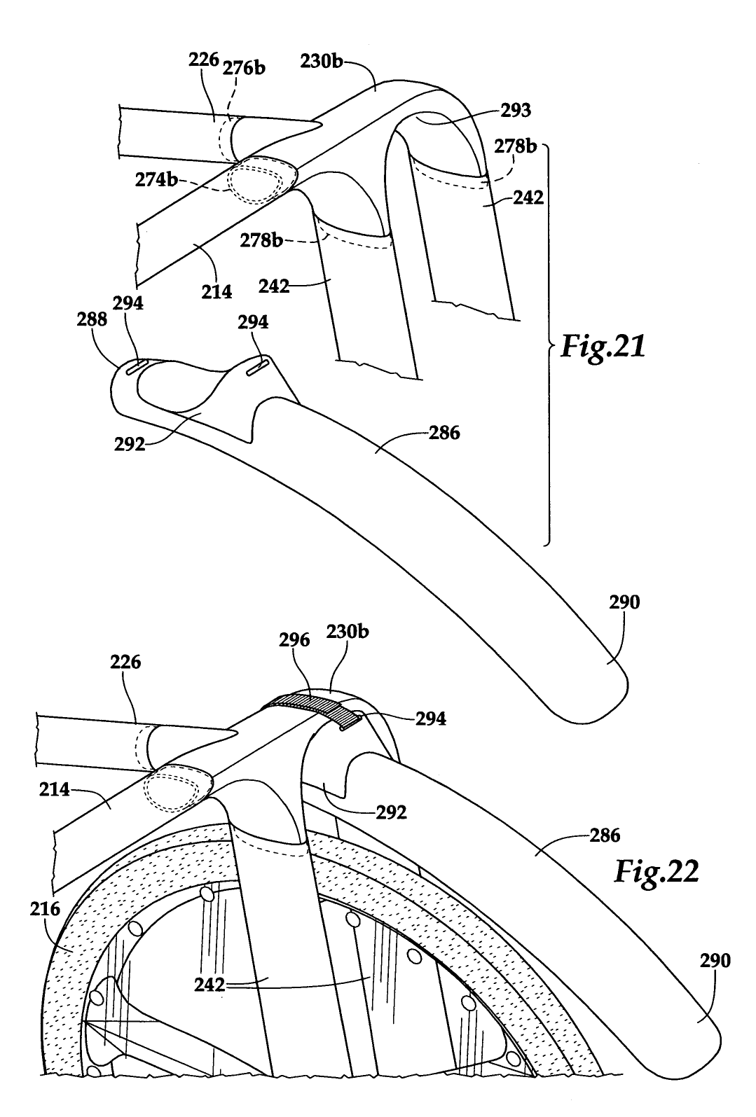

Turning to FIGS. 21 and 22, when sulky 210 is to be used on a muddy track, such as in a race after a rain storm, a novel mud fender 286 is connected to sulky 210 above each wheel 216 so that mud will not spray up from wheels 216 during the race. In one embodiment, mud fenders 286 include a front end 288 and a rear end 290. Fender 286 is concave with respect to wheel 216 when mud fender is mounted and is curved so that it is contoured with wheel 216. Front end 288 includes a saddle 292 having a geometric shape that corresponds to the shape of the underside 293 of connector 230a, 230b so that saddle 292 will fit snugly against connector 230a between struts 242, as shown in FIG. 22. A slot 294 for a strap 296 is included on each end of saddle 292, wherein strap 296 extends through each slot 294 and around connector 230a, 230b. Strap 296 is tightened down to bind mud fender 286 to connector 230a, 230b so that fender 286 is secure during a race. Mud fender 286 will not be used for all races, therefore, in one embodiment, strap 296 includes Velcro so that strap 296 can be easily tightened and secured, and then easily removed when mud fender 286 is no longer needed, allowing for quick attachment and quick release of fender 286 from sulky 210.

2.4 Rails

In one embodiment, each rail 224, 226 includes a cast generally T-shaped connector 258a, 258b having three pilots 259a, 259b, 260a, 260b, 262a, 262b, a rear tube 308a, 308b having a rear end 309a, 309b slidably engaged with a forwardly extending pilot 276a, 276b of connector 230a, 230b and a front end 310a, 310b slidably engaged with a rearwardly extending pilot 259a, 259b of T-connector 258a, 258b, a front tube 312a, 312b having a rear end 313a, 313b slidably connected to a forwardly extending pilot 260a, 260b of T-connector 258a, 258b and a front end 314a, 314b, wherein front end 248a, 248b of support 246a, 246b slidably engages an outwardly extending pilot 262a, 262b of T-connector 258.

Turning to FIG. 14, rear tubes 308a, 208b of rails 224, 226 may include angled portions 266a, 266b that are angled inwardly toward center lines 202, 204. However, because rear end 309a, 309b of rear tube 308a, 308b is slidably engaged with pilot 276a, 276b of connector 230a, 230b, it is preferred that rear tubes 308a, 308b include a short portion 316a, 316b generally perpendicular to arch 214 that corresponds to pilot 276a, 276a, which also is generally perpendicular to arch 214. Generally perpendicular pilots 276a, 276b and portions 316a, 316b are stronger because pilots 276a, 276b are generally perpendicular to arch 214, allow rails 224, 226 to pull evenly longitudinally forwardly on arch 214, and allow the angles of angled rail portions 266a, 266b to be adjusted without having to adjust the angle of pilot 276a, 276b with respect to arch 214.

Each rail 224, 226 may include a harnessing shaft 272 at distal 232a, 232b which is harnessed to horse 200. Rails 224, 226 extend forwardly from arch 214 generally in a common plane until harnessing shafts 272, which are bent vertically with respect to the rest of rails 224, 226 so that harnessing shafts 272 are generally horizontal and generally parallel to ground 206 when hitched to horse 200, as shown in FIG. 15. Harnessing shafts 272 may be made by casting, as with connectors 230a, 230b, 254a, 254b, 258a, 258b, or drop forged, and preferably, harnessing shafts 272 are machined to form bullets and a pilot 273 for slidably engaging front end 314a, 314b of front tube 312a, 312b of rails 224, 226, as shown in FIGS. 17 and 18.

Continuing with FIGS. 17 and 18, T-connector 258a, 258b may also include a longitudinally extending bracket 318 having a slot 320 for mounting a corresponding stirrup 238a, 238b thereto, wherein bracket 318 allows for longitudinal adjustment of stirrup 238a, 238b. In a preferred embodiment, bracket 318 is formed as part of cast T-connector 258a, 258b in the same casting process. Stirrups 238a, 238b are preferably formed by casting, and include knurling for engaging the soles of a driver's shoes. In one embodiment, best seen in FIG. 16, stirrups 238a, 238b do not substantially extend vertically below rails 224, 226, providing less aerodynamic drag, and reducing the likelihood of horse 200 kicking stirrups 238a, 238b during a race. Each stirrup 238a, 238b includes a stem 322 which extends through slot 320 and a fastener (not shown) to mount stirrup 238a, 238b to bracket 318. If a user wishes to adjust the longitudinal position of stirrup 238a, 238b, the fastener is loosened allowing stem 322 to slide along slot 320. When stirrup 238a, 238b is located at the desired location, the user tightens the fastener, locking stem 322 in place in slot 320, keeping stirrup 238a, 238b in the desired longitudinal position. Preferably, the fastener includes a recess for an Allen wrench so that the user can easily loosen and tighten the fastener.

2.5 Engagement Between Pilots and Tubes

The pilots of connectors 230a, 230b, 252a, 252b and 258a, 258b are slidably engaged with the tubes of arch 214, rails 224, 226, struts 242, and supports 246a, 246b. The connectors are cast so that the pilots are located and oriented in the proper location. The slidable engagement between the cast connectors and the tubes substantially coaxially align the pilots with the corresponding tubes to ensure that the tubes are aligned and oriented properly with respect to each other. In one embodiment, best seen in FIGS. 17-20, the pilots are slightly smaller than the inner diameter of the tubes so that the pilots fit radially and axially within their respective tubes for slidable engagement there between.

After slidably engaging pilots with their respective tubes, the connectors and tubes are connected together by some means, such as with an adhesive, braising, fasteners, sweat fitting, or other connecting means. Preferably, the connectors and tubes are welded together at the pilots wherein the weld extends substantially around the entire circumference of each pilot and tube to provide a strong and secure connection. It has been found that a circumferential weld between two slidably engaged parts is considerably stronger than a butt weld between two abutted tubes. In one embodiment, the connectors and tubes parts are welded using tungsten arc welding, also known as TIG welding, because it provides a high quality and precise weld and because it is a low heat weld so that there is less likelihood of the tubes warping due to the weld.

Continuing with FIGS. 13, 14, 17, and 18, in one embodiment, sulky 210 includes a tubular arch 214 having two ends 218a, 218b, a seat assembly 223 depending from arch 214, a pair of cast hollow 4-way connectors 230a, 230b, a pair of rails 224, 226 and a pair of wheel assemblies 234. Cast 4-way connectors 230a, 230b each include four pilots 274a, 274b, 276a, 276b, 278a, 278b, 279a, 279b one pilot 274a, 274b of each 4-way connector 230a, 230b slidably engaging and welded to a corresponding end 218a, 218b of arch 214. Rails 224, 226 each include a cast hollow T-connector 258a, 258b having three pilots 259a, 259b, 260a, 260b, 262a, 262b, a rear tube 308a, 208b having one end 310a, 310b slidably engaging and welded to one of the T-connector pilots 259a, 259b and one end 309a, 309b slidably engaging and welded to one of the 4-way connector pilots 246a, 246b, a front tube 312a, 312b, having one end 313a, 313b slidably engaging and welded to one of the T-connector pilots 260a, 260b, and a harnessing shaft 272 slidably engaging and welded to an opposite end 314a, 314b of front tube 312a, 312b for harnessing to horse 200. Wheel assemblies 234 each depend from an opposite end 218a, 218b of arch 214, wherein each wheel assembly 234 includes a pair of axle-receiving castings 328, each having a slot 329 and two pilots 330, 332, a pair of tubular struts 242, each having one end 280 slidably engaging and welded to one of the 4-way connector pilots 278a, 278b, 279a, 279b and one end 282 slidably engaging and welded to one of the axle-receiving casting pilots 330, a wheel 216 mounted on an axle 217, axle 217 being received by slots 329 of the pair of axle receiving castings 328, a cast hollow Y-connector 252a, 252b having three pilots 253a, 253b, 254a, 254b, a tubular arm 256a, 256b having one end 300a, 300b slidably engaging and welded to one of the T-connector pilots 262a, 262b and one end 302a, 302b slidably engaging and welded to one of the Y-connector pilots 253a, 253b, and a pair of tubular legs 264, each having one end 304 slidably engaging and welded to one of the Y-connector pilots 254a, 254b and one end 306 slidably engaging and welded to one of the axle-receiving casting pilots 332.

2.6 Seat Assembly

Turning to FIG. 17, seat assembly 223 comprises a middle tube 352 having two ends 354 and a pair of cast pieces 334 each incorporating a seat mounting bracket 336 and a tube 338 having an inwardly directed pilot 342 and an outwardly directed pilot 340, wherein each inwardly directed pilot 342 slidably engages an end 354 of middle tube 352, and wherein arch 214 comprises a pair of tubes 344, 348 each having an outer end 346, 350 and an inner end 345, 349, wherein each outer end 346, 350 slidably engages a laterally extending pilot 274 of one of the 4-way connectors 230 and each inner end 345, 349 slidably engages outwardly directed pilot 340 of seat assembly 223. Each bracket 336 includes slots, shown in FIG. 14, for receiving a fastener for mounting seat 222 to brackets 336. Preferably, the fastener includes a recess for an Allen wrench so that the user can easily loosen and tighten the fastener to adjust the position of seat 222 along brackets 336. In one embodiment, the fastener for mounting seat 222 to bracket 336 can be tightened or loosened by the same size Allen wrench as that used for the fastener for mounting stirrups 238a, 238b to bracket 318, described above, so that a user only needs one wrench to adjust the parts of sulky 210. In the embodiment shown in FIGS. 14 and 17, wherein distal end center line 204 is offset from the wheel center line 202, outside tube 348 of arch 214 is longer than inside tube 344 so that seat 222 is centered with respect to the offset distal end center line 204. The seat assembly may also include a single cast piece (not shown) having a pair of seat mounting brackets and a pair of pilots, wherein one pilot slidably engages the inside tube, and one pilot slidably engages the outside tube.

2.7 Material of Construction

Sulky 210 is made from a strong, flexible, and lightweight material. Examples of materials sulky 210 may be made include steel alloys, aluminum and its alloys, titanium and its alloys, magnesium and its alloys, and carbon fiber. In one embodiment, sulky 210 is made from steel, such as 1018 steel, and preferably sulky 210 is made from 4130 aircraft steel because it is strong, has a flexibility appropriate for sulky racing, and is light.

2.8 Offset Rails

Sulky 210 may include rails 224, 226 which are offset from wheels 216, as described above. In the embodiment shown in FIGS. 13-16, as inside rail 224 extends from arch 214 to distal end 232a, inside rail 224 includes point A′ at proximal end 228a where inside rail 224 is fitted to arch 214, an inward bend B′, an outward bend C′, an inward bend D′, an outward bend E′, an inward bend F′, an outward bend G′, and point H′ at distal end 232a. As outside rail 226 extends from arch 214 to distal end 232b, outside rail 226 includes point J′ at proximal end 228b, inward bend K′, outward bend L′, inward bend M′, outward bend N′, inward bend P′, outward bend Q′, and point R′ at distal end 232b.

Preferably, rail portions 316a, 316b that are connected to arch 214, i.e., between points A′ and B′ of inside rail 224 and between points J′ and K′ of outside rail 226, extend generally perpendicularly from arch 214 and generally parallel to center lines 202, 204 for a short distance of between about 1 inch and about 4 inches, preferably between about 2 inches and about 3 inches, still more preferably about 2½ inches. Perpendicularly extending portions 316a, 316b allow changes to the design of rails 224, 226, i.e. different angles for angled portions 266a, 266b, without changing the connection between rail 224, 226 and arch 214 (described above).

Continuing with FIG. 14, both rails 224, 226 may have a portion 266a, 266b that is angled inwardly toward center lines 202, 204. If present, the offset of distal end center line 204 may be accomplished by angled portion 266b of outside rail 226 being angled inwardly toward center lines 202, 204 more than angled portion 266a of inside rail 224. Preferably, angled portions 266a, 266b of rails 224, 226 are located proximate arch 214 so that the offset occurs proximate the driver. Preferably, the portions of rails 224, 226 forward from angled portions 266a, 266b, i.e., between points C′ and H′ on inside rail 224 and between points L′ and R′ on outside rail 226, are generally symmetrical about distal end center line 204. A stirrup portion 267a, 267b of each rail 224, 226 extends generally longitudinally forwardly from bend C′, L′ to bend D′, M′, where a short angled portion 268a, 268b is angled inwardly. Outward bend E′, N′ bends rail 224, 226 back outwardly to a generally longitudinally extending portion 270a, 270b that extends between bend E′, N′ to bend F′, P′. Bend F′, P′ bends rails 224, 226 inwardly at angled portions 271a, 271b, and bend G′, Q′ bends rails 224, 226 outwardly to a generally longitudinally extending harnessing shaft 272a, 272b between bend G′, Q′ and point H′, R′.

Angled portion 266a of inside rail 224 is angled toward center lines 202, 204 at an angle δ′ as angled portion 266a extends from arch 214 toward distal end 232a and angled portion 266b of outside rail 226 proximate arch 214 is angled toward center lines 202, 204 at an angle γ as angled portion 266b extends from arch 214 toward distal end 232b. Preferably, angle γ of angled portion 266b is larger than angle δ′ of angled portion 266a of inside rail 224 and outside rail angled portion 266b and inside rail angled portion 266a both extend in the longitudinal direction for substantially the same distance so that distal end center line 204 is offset from wheel center line 202.

In one embodiment, shown in FIG. 14, angled portion 266b of outside rail 226 is proximate arch 214 and is angled inwardly toward center lines 202, 204 as outside rail 226 extends forwardly by an angle γ of between about 15° and about 40°, preferably between about 20° and about 30°, still more preferably about 25°, and angled portion 266a of inside rail 224 is also proximate arch 214 and is angled inwardly toward center lines 202, 204 as inside rail 224 extends forwardly by an angle δ′ of between about 1° and about 20°, preferably between about 5° and about 15°, still more preferably about 9°.

The offset between wheel center line 202 and distal end center line 204 may be between about 1½ inches and about 4 inches, preferably between about 2 inches and about 3½ inches, still more preferably between about 2½ inches and about 3 inches.

In one embodiment, seat 222 is mounted to arch 214 so that seat 222 also is offset from wheel center line 202. Preferably, seat 222 is offset so that it is centered with respect to distal end center line 204, as shown in FIG. 14, so that the driver may be positioned behind horse 200 so that horse 200 provides a drafting effect to reduce aerodynamic drag during the race.

Portions 270a, 270b are positioned with respect to harnessing shaft 272, where horse 200 is harnessed, so that portions 270a, 270b are closely spaced from the hindquarters 201 of horse 200, as shown in FIG. 14. The close spacing allows sulky 210 to be guided by the close spacing between rail portions 270a, 270b and horse 200, keeping sulky 210 generally aligned with horse 200 and preventing lateral jarring or other lateral movement of sulky 210 during a race. Preferably, each portion 270a, 270b is between about ½ inch and about 2 inch from the hindquarters 201 of horse 200, preferably about 1 inch. The distance between guiding portions 270a, 270b of rails 224, 226 may be between about 28 inches and about 32 inches, preferably about 30 inches. Angled portions 270a, 270b are also positioned so that they are relatively close to the horse as portions 270a, 270b expand outwardly from distal ends 232a, 232b toward arch 214 to accommodate hindquarters 201 of horse 200.

Preferably, guiding portions 270a, 270b are generally parallel to one another and to center lines 202, 204 so that portions 270a, 270b are guided by the horse over a longitudinal range to accommodate different horse lengths or hitching points. In one embodiment, guiding portions 270a, 270b are positioned so that they are in directly in front of stirrups 238, so that guiding portions 270a, 270b provide a drafting effect for the feet of the driver and the stirrups, best seen in FIG. 14, reducing drag on stirrup 238 and the driver's foot during a race.

Harnessing shafts 272 are harnessed to horse 200 and include bullets 236 which are hitched to the harness on horse 200. Preferably, harnessing shafts 272 are generally parallel to each other and to center line 204 so that horse 200 can be harnessed at various longitudinal positions with respect to rails 224, 226.

3.0 Method of Making

Sulky 10 may be made from a conventional method of manufacturing racing sulkies, i.e. positioning tubes adjacent to each other and butt-welding them together to form arch 14, struts 42, 44, rails 24, 26, and supports 46 followed by mounting wheels 16 to struts 42.

Sulky 210 is manufactured using a fixture or jig (not shown) that corresponds to the desired configuration of sulky 210. The fixture holds arch 214, rails 224, 226, struts 242, supports 246, connectors 230a, 230b, 258a, 258b, 252a, 252b, and axle-castings 328 so that they will be oriented properly with respect to each other so that when horse 200 is harnessed to a completed sulky 210, wheels 216 are generally parallel to center lines 202, 204 so that wheels 216 do not plow or drag, slowing down horse 200 during the race. The preferred method of making sulky 210 includes casting each of the 4-way connectors 230a, 230b, the axle-castings 328, the T-connectors 258a, 258b, and the Y-connectors 252a, 252b, and in one method, the harnessing shafts 272 are also made by casting. The method continues by providing tubes for arch 214, rails 224, 226, and struts 242, and supports 246a, 246b, wherein each tube has the desired cross-sectional shape, for example by providing cold-drawn or cold-rolled steel tubes, cutting the tubes to the desired length, and, if necessary, bending the tubes, i.e., precision bending rails 224, 226 with the proper angles, i.e. with a computer directing the precision bending. After the tubes are provided, the method includes placing axle-castings 328 into the fixture so that slots 329 are fitted onto posts within fixture, wherein the posts are aligned in a predetermined position, slidably engaging struts 242 with upwardly extending pilots 330 of axle-castings 328, slidably engaging downwardly extending pilots 278a, 278b, 279a, 279b of 4-way connectors 230a, 230b with struts 242, slidably engaging arch tubes 344, 348 with laterally extending pilots 274a, 274b of 4-way connectors 230a, 230b so that arch 214 extends between 4-way connectors 230a, 230b, slidably engaging proximal ends 309a, 309b of rear rail tubes 308a, 308b with forwardly extending pilots 276a, 276b of 4-way connectors 230a, 230b, slidably engaging pilots 259a, 259b of T-connectors 258a, 258b with front ends 310a, 310b of rear rail tubes 308a, 308b, slidably engaging front ends 300a, 300b of support arms 256a, 256b with outwardly extending pilots 262a, 262b of T-connectors 258a, 258b, slidably engaging forwardly extending pilots 253a, 253b of Y-connectors 252a, 252b with rear ends 302a, 302b of support arms 256a, 256b, slidably engaging front ends 304 of legs 264 with rearwardly extending pilots 254a, 245b of Y-connectors 252a, 252b, slidably engaging rear ends 306 of legs 264 with forwardly extending pilots 332 of axle-castings 328, slidably engaging rear ends 313a, 313b of front rail tubes 312a, 312b with forwardly extending pilots 260a, 260b of T-connectors 258a, 258b, and slidably engaging pilots 273 of harnessing shafts 272 with front ends 314a, 314b of front tubes 312a, 312b. The order of placing the parts of sulky 210 in the fixture and slidably engaging tubes with pilots can be varied so long as all the parts are placed in their correct position within the fixture so that the parts of sulky 210 are aligned properly.

After all the parts of sulky 210 are placed in the fixture and all the slidable engagements between pilots and tubes are accomplished, the fixture may be tightened down onto the parts of sulky 210 so that it holds the parts in their proper positions relative to one another, and the parts may be connected together, such as by welding. In a preferred method, each slidable engagement is spot welded in selected positions to keep the parts aligned, followed by welding all the way around the slidable engagement to provide strong and secure connections between the tubes and pilots. The fixture ensures proper alignment and positioning of the parts of sulky 210 before, during, and after welding so that wheels 216 will be substantially longitudinally aligned with center lines 202, 204 to prevent plowing or dragging of wheels 216.

The sulky of the present invention eliminates or alleviates many problems with conventional sulkies including providing a way to align the wheels to ensure that they are aligned with the direction the horse is pulling the sulky, a novel wheel assembly with substantially planar wheel covers, a novel way of allowing the horse and the sulky to track independently of each other, and a novel way of offsetting the horse from the center line between the wheels.

While the foregoing written description of the invention enables one of ordinary skill to make and use what is considered presently to be the best mode thereof, those of ordinary skill will understand and appreciate the existence of variations, combinations, and equivalents of the specific exemplary embodiment herein. The invention should therefore not be limited by the above described embodiments, but by all embodiments within the scope and spirit of the invention.

1. A sulky to be drawn by a horse having a longitudinal horse center line, comprising:
a pair of laterally spaced wheels mounted generally at opposite ends of a generally tubular arch, there being a longitudinal wheel center line between said pair of wheels;
a seat mounted to said arch between said ends and said wheels;
a first rail and a second rail extending from said arch, each rail having a proximal end mounted to said arch and a distal end adapted for harnessing to said horse, said first rail being mounted to said arch on one side of said seat and said second rail being mounted to said arch on the other side of said seat;
wherein a portion of said first rail proximate said arch is angled toward said wheel center line; and
wherein said wheel center line is offset from said horse center line.

2. A sulky according to claim 1, wherein said proximate portion of said first rail is angled at a first angle toward said wheel center line and wherein said second rail has a portion proximate said arch that is angled at a second angle toward said wheel center line, wherein said first angle is larger than said second angle.

3. A sulky according to claim 1, wherein said wheel center line is offset from said horse center line by between about 2 inches and about 3½ inches.

4. A sulky according to claim 1, wherein said seat is centered with respect to said horse center line.

5. A sulky according to claim 1, wherein each rail has a portion extending generally perpendicularly from said arch.

6. A sulky according to claim 1, wherein said arch is angled so that it is not substantially parallel to the ground when said rails are harnessed to said horse.

7. A sulky to be drawn by a horse, comprising:
a generally tubular arch having two ends;
a seat mounted to said arch between said ends;
a pair of strut assemblies depending downwardly from generally opposite ends of said arch, each of said strut assemblies for receiving a wheel;
a pair of rails mounted to said arch, one rail being mounted on one side of said seat and the other rail being mounted on the other side of said seat, each of said rails extending generally in a longitudinal direction from said arch to a distal end, said distal ends of said rails being adapted for harnessing said horse between said rails;
wherein said wheels are substantially longitudinally aligned.

8. A sulky to be drawn by a horse comprising:
a tubular arch including cast portions having pilots;
a seat assembly depending from said arch;
a pair of tubular rails each having one end slidably engaging one of said pilots and one end adapted for harnessing to said horse; and
a pair of wheel assemblies, each depending from an opposite end of said arch, each wheel assembly comprising a tubular strut having an upper end slidably engaging one of said pilots and a lower end, and a wheel mounted to said lower end of said strut.

9. A sulky according to claim 8, wherein said rails and said struts are welded to said cast portions at said pilots.

10. A sulky according to claim 8, wherein said tubular arch includes two ends, and said cast portions comprise a pair of cast connectors each having three pilots, one pilot of each connector slidably engaging a corresponding end of said arch, one pilot slidably engaging a corresponding one of said pair of rails, and one pilot slidably engaging said upper end of said tubular strut.

11. A sulky according to claim 10, wherein each of said cast connectors comprise four pilots and each of said wheel assemblies comprises a pair of tubular struts each having an upper end slidably engaging one of said connector pilots and a lower end, wherein said wheel is mounted between said lower ends of said pair of tubular struts.

12. A sulky according to claim 11, wherein there is a distance between said pair of struts above said wheel that is small enough to prevent a horse hoof from fitting between said struts.

13. A sulky according to claim 12, wherein said distance between said struts above said corresponding wheel is no more than about 3 inches.

14. A sulky according to claim 12, wherein each of said struts are thick enough to provide the small distance between said struts while providing a center-to-center distance between said lower ends of said struts of between about 4 inches and about 8 inches.

15. A sulky according to claim 11, wherein each of said wheel assemblies further comprises a support having a front end connected to a corresponding one of said pair of rails and a rear end connected to one of said struts.

16. A sulky according to claim 15, wherein each rail comprises a T-connector having three pilots, a rear tube having one end slidably engaging one of said connector pilots and one end slidably engaging one of said T-connector pilots, and a front tube having one end slidably engaging one of said T-connector pilots, and wherein said front end of said support slidably engages one of said T-connector pilots.

17. A sulky according to claim 16, wherein said T-connector includes a bracket for mounting a stirrup thereto, wherein said bracket allows for longitudinal adjustment of said stirrup.

18. A sulky according to claim 15, wherein each support comprises a Y-connector having three pilots, a tubular arm having a front end connected to said corresponding rail and a rear end slidably engaged with one of said Y-connector pilots, and a pair of tubular legs each having front end slidably engaging one of said Y-connector pilots and a rear end connected to one of said struts.

19. A sulky to be drawn by a horse comprising:
a tubular arch having two ends,
a seat assembly depending from said arch,
a pair of cast hollow 4-way connectors each having four pilots, one pilot of each 4-way connector slidably engaging a corresponding end of said arch,
a pair of rails, each rail comprising:
a cast hollow T-connector having three pilots,
a rear tube having one end slidably engaging and welded to one of said T-connector pilots and one end slidably engaging and welded to one of said 4-way connector pilots,
a front tube having one end slidably engaging and welded to one of said T-connector pilots, and
a harnessing shaft slidably engaging and welded to an opposite end of said front tube for harnessing to said horse,
a pair of wheel assemblies, each depending from an opposite end of said arch, each wheel assembly comprising:
a pair of axle-receiving castings, each having a slot and two pilots,
a pair of tubular struts, each having one end slidably engaging and welded to one of said 4-way connector pilots and one end slidably engaging and welded to one of said axle-receiving casting pilots;
a wheel mounted on an axle, said axle being received by said slots;
a cast hollow Y-connector having three pilots;
a tubular arm having one end slidably engaging and welded to one of said T-connector pilots and one end slidably engaging and welded to one of said Y-connector pilots; and
a pair of tubular legs, each having one end slidably engaging and welded to one of said Y-connector pilots and one end slidably engaging and welded to one of said axle-receiving casting pilots.

20. A sulky according to claim 19, wherein said arch is streamlined.

21. A sulky according to claim 19, wherein said seat assembly comprises a middle tube having two ends, and a pair of cast pieces each incorporating a seat mounting bracket and a tube having an inwardly directed pilot and an outwardly directed pilot, each inwardly directed pilot slidably engaging and welded to an end of said middle tube, and wherein said arch comprises a pair of tubes each having an outer end and an inner end, wherein said outer end slidably engages and is welded to a pilot of one of said 4-way connectors and said inner end slidably engages and is welded to outwardly directed pilot of said seat assembly

22. A sulky to be drawn by a horse, comprising:
a generally tubular arch having two ends;
a seat mounted to said arch between said ends;
a pair of strut assemblies depending downwardly from generally opposite ends of said arch, there being a wheel mounted to each of said strut assemblies;
a pair of rails mounted to said arch, one rail being mounted on one side of said seat and the other rail being mounted on the other side of said seat, each of said rails extending generally in a longitudinal direction from said arch to a distal end adapted for harnessing said horse between said rails;
a pair of supports, one support being connected to one of said rails at one end thereof and to one of said strut assemblies at the other end thereof and the other support being connected to the other of said rails at one end thereof and to the other of said strut assemblies at the other end thereof;
wherein the connection between each support and the corresponding rail is adjustable to allow for substantially longitudinal alignment of said wheels.

23. A sulky to be drawn by a horse, comprising:
a generally tubular arch having two ends;
a pair of laterally spaced wheels mounted generally at opposite ends of said arch;
a seat mounted to said arch between said ends and said wheels;
a pair of rails mounted to said arch and extending forwardly, one of said rails being mounted to said arch on one side of said seat, and the other of said rails being mounted to said arch on the other side of said seat, each rail having a proximal portion mounted to the arch and a distal portion pivotally connected to said proximal portion so that said distal portion can pivot with respect to said proximal portions;
each of said distal portions having a distal end adapted for harnessing said horse between said rails.

24. (canceled).

25. (canceled)

26. (canceled)

27. (canceled)

28. (canceled)
